(19) United States
(12) Patent Application Publication
(10) Pub. No.: US 2025/0121223 A1
(43) Pub. Date: Apr. 17, 2025

(54) Fire Detection and Warning Systems, Devices, and Methods for Kitchen Ventilation

(71) Applicant: Oy Halton Group Ltd., Helsinki (FI)

(72) Inventors: Andrey V. LIVCHAK, Bowling Green, KY (US); Jimmy SANDUSKY, Bowling Green, KY (US); Jacob LATHAM, Alvaton, KY (US)

(73) Assignee: Oy Halton Group Ltd., Helsinki (FI)

(21) Appl. No.: 18/696,007

(22) PCT Filed: Aug. 31, 2022
(86) PCT No.: PCT/US2022/075754

§ 371 Date: Mar. 27, 2024

Related U.S. Application Data
(60) Provisional application No. 63/251,274, filed on Oct. 1, 2021.

(51) Int. Cl. A62C 3/00; A62C 37/40; A62C 37/48; G06N 3/09; G08B 17/06

(52) U.S. Cl. CPC A62C 3/006; A62C 37/40; A62C 37/48; G08B 17/06; G06N 3/09

(57) ABSTRACT

A fire detection and warning system includes a kitchen exhaust hood connected to an exhaust fan configured to ventilate convective heat and cooking fumes released by one or more cooking appliances installed under the kitchen exhaust hood, the kitchen exhaust hood having a plenum. A fire suppression system is operatively connected to the hood and positioned above the one or more cooking appliances and configured to be triggered by one or more fusible links with a predefined melting temperature. At least one temperature sensor is installed inside the plenum of the kitchen exhaust hood and provides temperature measurements to a control module. The control module is configured to generate a fire warning signal in response to a fume temperature reaching a predefined temperature threshold Tset for a predefined period of time Tdur, where Tset and the time Tdur are selected based on a melting temperature rating the fusible links.

### CROSS-REFERENCE TO RELATED APPLICATIONS

None. This application claims priority to and the benefit of U.S. Provisional Patent Application No. 63/251,274 filed Oct. 1, 2021, which is hereby incorporated by reference in its entirety.

### BACKGROUND

Fire suppression systems are used in hoods placed over cook-stoves or ranges and are mainly concerned with delivering fire retardant onto the cooking surface to stop fat or grease fires when a temperature indicative of a fire is measured in the hood plenum or ductwork. The existing fire suppression systems operate by the release of fire retardant from a pressurized storage container and a through flow path when a mechanical valve opens in response to a fusible link melting due to high temperature near the fusible link.

Fusible links are temperature sensitive fire protection devices designed to be part of a fire protection system. The system is activated when the ambient temperature increases to the point that causes the fusible link to “break-apart”. Typically, the link or a part of it melts due to the chemical composition of the link. At the point of breakage, a valve is mechanically activated or a cable is released which in turn operates a remote valve to release a pre-loaded fire protection device, thus restricting the spread of fire.

In various configurations, a fusible link holds together two mechanical members which are under tension. Typically, the mechanical members are connected to a cable which can pass around the inner perimeter of a ventilation hood, with multiple mechanical members held together, under tension, by fusible links. The cable is connected to a dispensing mechanism which stores a fire suppressant chemical. When any one of the fusible links melts in response to the temperature experienced by the fusible link, the two mechanical members that were held by that fusible link are released and they release tension in the cable, which triggers the dispensing mechanism to release of the fire suppressant chemical.

Although the fusible link is one of the simplest forms of fire detection devices, and is therefore considered reliable and required by various building codes, it is difficult to select correct fusible links for any particular installation; and there is a risk of discharge of fire suppressant prematurely if an incorrect fusible link is selected.

There are many types of fusible links, with varying melting temperatures. When fusible links are being selected, the installer is supposed to heat up all appliances under the hood and measure the temperature inside the hood, and select one or more fusible links based on the measured temperature. However, in practice, this rarely happens. Instead, an installer may simply install the highest temperature fusible links available, in an effort to reduce the chance of the fire suppression system triggering. Such an installation may satisfy building codes, but does not improve safety. Accordingly, there is a need for a better method of selecting fusible link temperatures.

Furthermore, fusible link fire suppression systems, when triggered, cause the great disruption to a kitchen. It is desirable to provide warning before the fusible link fire suppression system is triggered, to provide an opportunity to mitigate or avoid the fire from breaking out and thus avoid the disruptive activation of the fire suppression system.

### SUMMARY

One or more embodiments of the disclosed subject matter provide a system, a device, and methods for selecting suitable fusible links; for providing advance warning prior to the deployment of a fusible link fire suppression system; and for retrofitting exhaust hoods with a warning system that warns of a possible fire before a fusible link fire suppression system is triggered.

Objects and advantages of embodiments of the disclosed subject matter will become apparent from the following description when considered in conjunction with the accompanying drawings.

### BRIEF DESCRIPTION OF THE DRAWINGS

Embodiments will hereinafter be described in detail below with reference to the accompanying drawings, wherein like reference numerals represent like elements. The accompanying drawings have not necessarily been drawn to scale. Some of the figures may have been simplified by the omission of selected features for the purpose of more clearly showing other underlying features. Such omissions of elements in some figures are not necessarily indicative of the presence or absence of particular elements in any of the exemplary embodiments, except as may be explicitly disclosed in the corresponding written description.

FIG. 1 shows a kitchen with fire detection and suppression elements according to embodiments of the disclosed subject matter.

FIG. 2 is a perspective view diagrammatically illustrating an exhaust hood system positioned above cooking appliances and having a fire warning and suppression control system according to various embodiments of the disclosed subject matter.

FIG. 3 is a view upward into a kitchen exhaust hood according to various embodiments of the disclosed subject matter.

FIG. 4 illustrates an example of a fusible link assembly according to embodiments of the disclosed subject matter.

FIG. 5 is a block diagram of an exemplary fire detection and warning system in accordance with embodiments of the disclosed subject matter.

FIG. 6 illustrates an exemplary implementation of the controllers used in various embodiments of the disclosed subject matter.

FIG. 7 illustrates an example of a method according to various embodiments of the disclosed subject matter.

### DETAILED DESCRIPTION

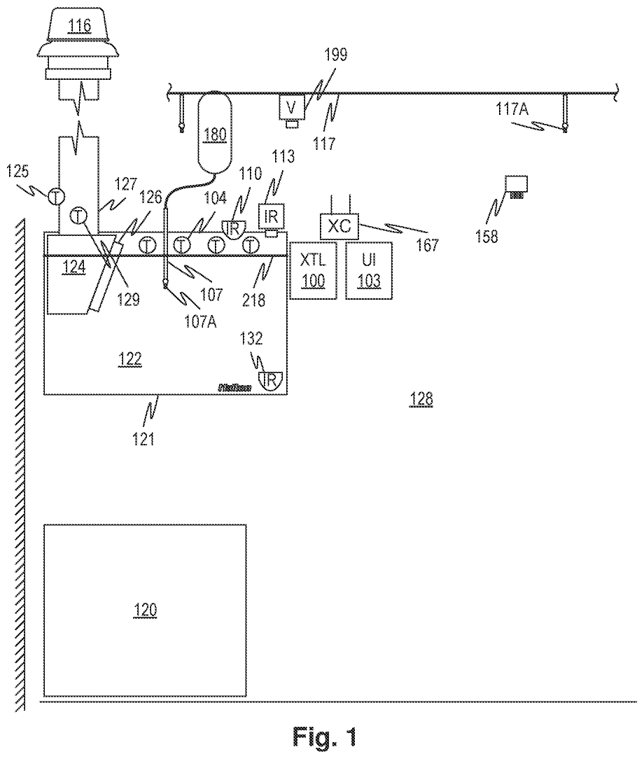

FIG. 1 illustrates a kitchen space 128 with systems and devices according to embodiments of the present disclosure. An exhaust fan 116 draws air and fumes from a duct 127 connected to an exhaust plenum 124 which supports a filter 126 at an inlet thereof to draw fumes from a recess 122 of an exhaust hood 121. There may be multiple plenums 124, filters 126, and ducts 127 in a variety of different arrangements and the present is shown only as an example. Various sensors are shown which will be discussed below.

A cooking appliance, which may be one of many types (e.g., grill, fryer, oven, pizza oven, etc.), is indicated at 120. The cooking appliance may generate cooking fumes 165 that are exhausted by the exhaust hood 121. Appliances 120 are generally positioned adjacent each other with a gap between adjacent ones of the appliances. Such spaces between appliances can be traps for dust, grease, old food, and many other detritus that may fuel a fire and thereby create a hazard.

A fire suppressant such as a chemical suppressant is stored in a pressurized container 180 or another suitable subsystem. A delivery apparatus 107 may include, for example, a spray nozzle 107A. Water sprinkler suppressants, dry or gas suppressants may also be provided.

A fire sprinkler system 117 with sprinkler heads 117A may also be present in a commercial kitchen space 128 and may be combined with the delivery apparatus 107 such that fire suppressant chemical is supplied from the fire sprinkler system 117 through spray nozzle(s) 107A.

The fire suppressant system, whether from pressurized container 180 and/or from the sprinkler system 117 may be configured to be triggered by fusible link assemblies 217 that cause fire suppressant to be emitted from the nozzles when heated for a predefined period above a predefined temperature. As shown in FIG. 3, the system may include a cable 218 which is held under tension by fusible link assemblies 217.

Referring now to FIG. 3, a view from the ground up toward the ceiling showing the interior of the exhaust hood 121 is shown. The exhaust duct 127 can be seen at the end of exhaust plenum 124. In this example, cable 218 is shown extending around the perimeter of the exhaust hood 121. Four fusible link assemblies 217 are shown in this example. The number of the fusible link assemblies may be selected based on the kitchen appliances which are positioned underneath the exhaust hood 121, such that each fusible link assembly 217 is vertically aligned with a kitchen appliance which may be expected to reach a high temperature in case of a fire condition.

As explained above, the fusible link assembly includes a fusible link 413 which is supposed to be selected based on the particular kitchen configuration. However, that is often not the case. As shown in FIG. 3, a temperature sensor 104 is positioned in close proximity, such as within 5 cm, within 10 cm, within 15 cm, or within 20 cm of each fusible link assembly 217. Although not illustrated in FIG. 3, each temperature sensor 104 is connected to the controller 100. Thus, a temperature reading from the close of the city of each fusible link assembly 217 can be made continuously, or at regular intervals.

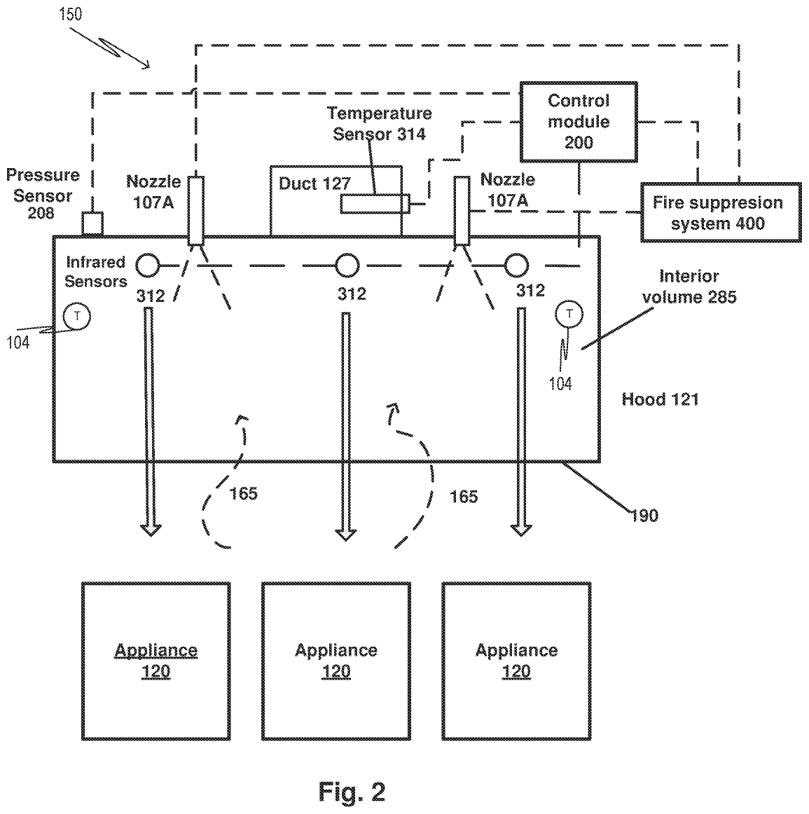

The controller 100 may continuously or intermittently monitor one or more inputs ultimately derived from the various sensors, examples of which are collectively illustrated in FIGS. 1 and 2. The sensors may include temperature sensors 104, 125, and 129. Various other types of temperature sensors may also be employed here and elsewhere in the embodiments disclosed throughout the present application. These may include thermocouples, resistance temperature sensors, resistance temperature sensors (RTDs), quartz oscillator thermometers, thermistors, or any other type of temperature sensor. One or more temperature sensors 104 may be provided in the recess 122 of the exhaust hood 121. Temperature sensor(s) 125 may be disposed in a location that allows the measurement of ambient temperature outside of the duct 127, and/or the surface temperature of the surface of the material from which duct 127 is made. Temperature sensor(s) 127 may be positioned such that it measures air temperature inside of duct 127. In embodiments, the various temperature sensors are analog thermistors whose electrical resistance changes based on their temperature.

Temperature sensors 104 may be distributed in a rectangular or hexagonal array over a two dimensional field within the recess 122 of the exhaust hood 121. The positions indicated in FIG. 1 are figurative only. As indicated above, the temperature sensors 104 may be used to indicate a slowly varying temperature or fluctuating temperature from which statistics may be derived and used for classification to indicate a fire. Examples of temperature sensors with low thermal inertia are RTDs and thermocouples as well as thermistors.

Radiant emissions, or light energy in the thermal range, may be detected and used for fire detection and/or for discriminating a non-fire condition given indications, by other sensors. The sensors may further include one or more radiant temperature sensors such as 132 positioned and aimed to detect the average temperature of a region (field of view or FOV) or radiant sensors that are aimed at fusible links of the fire suppression system. There may be multiple radiant temperature sensors aimed at multiple regions or FOVs. For example, one indicated at 132 may be directed at a portion of the cooking surface of the appliance 120 while another radiant sensor 110 is positioned to detect flames in the exhaust hood 121 recess 122. The FOV may be narrow or broad. In embodiments, the FOV is selectable. The signal provided by the radiant temperature sensors 110 may be a real-time instantaneous signal from which information may be obtained by the controller form the unsteady signal therefrom.

Radiant temperature of a region may be spatially resolved by one or more infrared cameras 113 and combined by the controller do detect a fire or a situation that is otherwise dangerous.

An optical or infrared video imaging device 199 (e.g., video camera, CCD sensor, FLIR sensor, etc.) may be mounted so as to detect emergence of fire or hot water vapor-containing fumes from a plan view of a hood. The video camera 199 may be selected based on a broad range of optical and near infrared frequencies. A recognition algorithm implemented by the controller 100 may recognize the escape of fire or fumes from the hood. Fumes and, of course, fire, should not be visible from above the hood 121 under normal circumstances. The expansion of combustible vapor under the hood forcibly escapes the regulated from of exhaust so that fire and hot smoke can readily be detected. In addition, employing an image or video capture device such as camera 199 for this purpose allows the volume of escaping gases, if not extreme, to be quantified to some extent, in that a radiant temperature and area of a projection of a radiant plume can be quantified with the help of image processing.

In a method, the controller may delay outputting a fire indication or controlling an output effecter such as an alarm or fire suppression system in order to provide time for a manual override to be entered by an operator. The controller may, according to the method embodiment encoded by processor-executable instructions, provide a warning signal indicating that a provisional fire detection has occurred, thereby alerting operators to the need for an override input to prevent an alarm or suppression output.

Video scene classification techniques utilizing artificial intelligence (e.g., supervised learning) can be applied to recognize hazardous situations before they actually generate a fire. The system can monitor various sensors and also the fusible link fire suppression system. If the fire suppression system ever triggers, the conditions that led up to the triggering will be stored by the controller for post-analysis and will form a part of a dataset for the supervised learning that will be able to recognize and predict the occurrence of a fire.

Classification of hazards can cause a controller to generate a warning using any of the disclosed mechanisms without necessarily or immediately triggering a fire suppression system in response. For example, an infrared image of a blob in a scene, where the hot blob is determined to have a temperature that is rising toward a predefined flashpoint of oil and where no activity is indicated by motion analysis of the scene would be a simple classification problem that could be defined in a classifier by explicit rules or implemented using supervised learning. Such a scene would be an indication of a possible fire waiting to happen.

A controller 100 may be connected to a remote or mobile UI (user interface), such as a smartphone, by a communications module 167. The communications module 167 may be a network or Internet interface such as a modem and may include a router or switch. The communications module 167 may be a transceiver and the mobile UI, a radio terminal.

An urgent condition may be the detection of a fire breakout at a nearby location. These signals may be combined with textual output on the user interface 103 explaining the meaning and type of warning and the action to take. A visual signal generator, such as a strobe light 158, may be provided to concurrently or alternatively output signals. An audible signal generator, such as an alarm, siren, or loudspeaker may also be provided and operatively coupled to the system to output alerts when commanded by the controller 100.

Referring to FIG. 2, there is shown an exemplary exhaust ventilation system including an exhaust hood 121 positioned above a plurality of cooking appliances 120 and provided in communication with an exhaust assembly (not shown) through an exhaust duct 127. A bottom opening of the exhaust hood 121 may be generally rectangular but may have any other desired shape. Walls of the hood 121 define an interior volume 285, also referred to as a plenum, which communicates with a downwardly facing bottom opening 190 at an end of the hood 121 that is positioned over the cooking appliances 120. The interior volume 285 may also communicate with the exhaust assembly through the exhaust duct 127. The exhaust duct 127 may extend upwardly toward the outside venting environment through the exhaust assembly.

The exhaust assembly may include a motorized exhaust fan (not shown), by which the exhaust air generated by the cooking appliances 120 is drawn into the exhaust duct 127 and for expelling into the outside venting environment. When the motor of the exhaust fan is running, an exhaust air flow path is established between the cooking appliances 120 and the outside venting environment. As the air is pulled away from the cook top area, fumes, air pollutants and other air particles are exhausted into the outside venting environment through the exhaust duct 127 and exhaust assembly. One or more pressure sensors 208 may also be included in the exhaust ventilation system 150 to measure the static pressure in the main exhaust duct, as well as a plurality of grease removing filters (not shown) at the exhaust hood 121 bottom opening 190 to remove grease and fume particles from entering the hood exhaust duct 127.

The exhaust ventilating system 150 may further include a control module 200 which preferably includes a programmable processor that is operably coupled to, and receives data from, a plurality of sensors, including temperature sensors 104, and is configured to detect a fire condition and to output a warning, and optionally trigger a portion of the fire suppression system. The controller may also control the speed of the motorized exhaust fan, which in turn regulates the exhaust air flow rate in the system. The control module 200 communicates with the motorized exhaust fan which includes a speed control module such as a variable frequency drive (VFD) to control the speed of the motor, as well as one or more motorized balancing dampers (not shown) positioned near the exhaust duct 127.

The control module 200 is also configured to control activation and deactivation of a fire suppression mechanism 400 based on the temperature inside of the hood 121 in addition to, or instead of, the fusible link fire suppression system (e.g., 117 and 180 shown in FIG. 1). That is, the two fire suppression approaches can be combined, such that the fusible link fire suppression system provides a fail-safe fire suppression functionality due to the physical nature of the fusible links 413 that will necessarily melt at a certain high temperature. The fire suppression system 400, on the other hand, can be controlled by the control module 200 to initiate fire suppression at specific locations, such as only a single appliance, or only a single location of a cooking surface. This way localized and more fine-tuned fire suppression is possible, while at the same time providing a failsafe functionality of a fusible link system. This approach can reduce the disruption caused by the fusible-link fire suppression being activated, as such activation can often cause the shutdown of the kitchen with extensive cleaning, and inspection and recommissioning of the fusible-link fire suppression system before the kitchen can reopen.

In addition, or instead of, controlling fire suppression, the control module 200 may also detect a fire condition and issue a warning through a user interface attached to the exhaust hood 121, or through a remote device (such as through a network interface to hand-held devices of the users) warning of the fire condition before the fusible-link fire suppression system is triggered.

The control module 200 can also control the exhaust fan speed and the activation of the fire suppression mechanism 400 based on the output of a sensor 314 positioned on or in the interior of the exhaust duct 127, and the output of infrared (IR) radiant temperature sensors 312, each positioned to face an upper surface of a respective cooking appliance 120. In at least one embodiment, three IR sensors 312 may be provided, each one positioned above a respective cooking appliance 120, so that each IR sensor 312 faces a respective cooking surface of appliance 120. However, any number and type of IR sensors 312 and any number of cooking appliances 120 may be used, as long as the radiant temperature of each cooking surface is detected. The control module 200 communicates with sensors 314 and 312 and identifies the cooking appliance status based on the sensor readings. The status of the cooking appliances 120 is determined based on the exhaust air temperature and the radiant temperature sensed using these multiple detectors.

Note that radiant temperature sensors may include, or be supplemented by one or more IR cameras and one or more optical cameras. A single camera may produce “color” channel of a video signal to allow a single video stream to indicate temperature and luminance at a large number of locations in real time. In fact, a single video camera detecting IR color and optical bands may replace all of the radiant temperature sensors 312. The combination of optical and IR signals can be particularly useful in combination. For example, a high sustained infrared signal without a contemporaneous optical signal may be classified by a controller as a hot grill while the same IR signal coupled with a strong or fluctuating optical signal may be classified as a fire. The spatial information provided by a camera may further aid in the disambiguation of combined signals.

Images, optical, IR or both may be image-processed to generate a state vector of reduced dimensionality as an input for training and recognizing fire and cooking events. Many examples of normal cooking and fire conditions may be used to train a supervised learning algorithm which may then be used to recognize and classify, respectively, normal cooking and fire conditions.

Note that any of the embodiments may be modified by including fire control nozzles that have fusible links. In such an embodiment, a fusible link sprinkler head may be provided with a parallel feed that is controlled by a control valve for the fire suppression system. In the event of a failure of the control system, the fusible link can open its parallel supply of water causing water to be sprayed on the enabling heat source, presumably a fire.

The fire suppression mechanism 400 may include, store, and/or regulate the flow of, a fire control section including any known fire retardant material source capable of extinguish fire. Fire suppression mechanism 400 may further include a section that communicates with a digital network that interconnects other systems that control and/or indicate status information regarding, ventilation fans, filters, lighting, ductwork, cooking appliances, food order-taking, invoicing, inventory, public address, and/or any other components. For example, a signal may be generated on such a network to notify occupants and/or fire-fighting agencies of a detected fire condition, in addition to the activation of the fire suppression process.

Although shown as separate elements, nozzles 107A may be integral with the fire suppression mechanism 400. The structure illustrated may be one in which one or more separate nozzles are connected to the fire suppression mechanism 400 by fluid channels. Nozzles 107A may be strategically placed inside of the ventilation system 150 so as to be able to extinguish the fire regardless of its source. For example, one or more nozzles 107A may be placed in the grease collection area and one or more nozzles 107A may be positioned directly above the cooking appliance 120. The nozzles 107A communicate directly with the fire control section of the fire suppression mechanism 400 so that when the mechanism 400 is activated by the control module 200, fire retardant material is discharged through the nozzles 107A. The fire retardant may be any known fire extinguishing material, such as, but not limited to water, or liquid potassium salt solution.

The control module 200 may also determine a cooking appliance status (AS) based on the exhaust temperature sensor 314 and the IR radiant temperature sensor 312 outputs, and may change the exhaust fan speed as well as the position of the motorized balancing dampers in response to the determined cooking appliance status (AS). The control module 200 may also activate the fire suppression mechanism 400 based on a detected appliance status.

Referring again to FIG. 3, a fire suppressant such as a chemical suppressant is stored in a pressurized container 180 or another suitable subsystem. A delivery apparatus 107 may include, for example, a spray nozzle 107A. Water sprinkler suppressants, dry or gas suppressants may also be provided.

A fire sprinkler system 117 with sprinkler heads 117A may also be present in a commercial kitchen space 128 and may be combined with the delivery apparatus 107 such that fire suppressant chemical is supplied from the fire sprinkler system 117 through spray nozzle(s) 107A.

In certain embodiments, there is a single temperature sensor positioned above, or directly above, the kitchen appliance that has the highest heat signature for the highest fire risk. For example, this could be a hard oil fryer that is powered by a gas burner. In another example, this appliance could be a solid fuel powered appliance, such as a coal or wood fired oven. By placing the temperature sensor above such an appliance, that has the highest heat signature, it is possible to detect a rise in temperature that could eventually melt a fusible laying and because the fire suppression system to be discharged. That is, the early detection of this dangerous temperature condition can be made through strategic placement of the temperature sensor.

In certain embodiments, there are 2 temperature sensors positioned at 2 opposite ends of the plenum (the interior volume) of the exhaust hood above multiple cooking appliances. Using 2 temperature sensors space apart as described above and positioned at opposite ends of the plenum, allows sensing the overall cooking area, and measuring temperature rise which is caused by all of the appliances. As noted above, the temperature sensors can measure an increase in temperature and detect a situation which could eventually lead to a fusible link melting and discharging fire suppressant. By detecting the temperature rise early, it is possible to take other actions, such as issuing warnings, activating localized fire suppression which may suppress a small, localized fire, and turning of power cooking appliances.

A control module receives signals indicating temperature measured by the temperature sensor or sensors in the kitchen exhaust hood plan. The control module is specifically configured, a programmed, perform a method which is described in greater detail below. In general terms, control module monitors the temperature readings and generates a fire warning signal in response to a fume temperature measured in the plenum exceeding a certain temperature threshold (Tset) for a certain duration of time (Tdur). This allows the control module to effectively integrate the measure of heat energy that is being generated and compare that to a melting temperature of the fusible link or links that are used in the fire suppression system. As will be understood, there are many types of fusible links and they are differentiated by their melting temperature and duration for which they can withstand the temperature before they melt. If heat of a sufficient intensity is applied to a fusible link for a sufficient duration, the link will melt, triggering the fire suppression system. The control module is configured and specifically programmed based on the fusible link rating to be able to predict before the lake melts that there is a risk of the lake melting. This can be accomplished, as described above, by monitoring one or more temperature readings and noting when the temperature readings exceed a specific threshold temperature and the duration for which the threshold is exceeded.

In an embodiment, the temperature rating, the size, and material fusible link is used to define a maximum heat load that the fusible link can withstand before failing (i.e., melting). The control module monitors with temperature signals provided by one or more temperature sensors and the duration of the various temperature readings to calculate the current he flowed, and the cumulative load. This way, the control module is able to predict that the fusible link is about to fail before the actual failure.

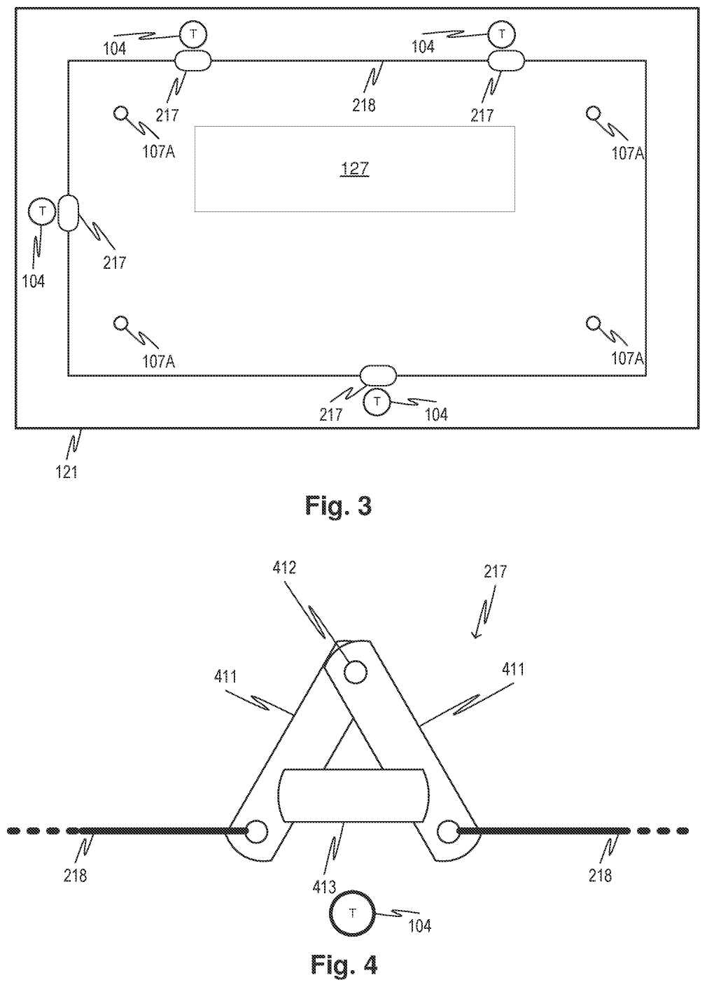

Turning to FIG. 4, details of an exemplary fusible link assembly 217 are shown. Two articulating arms 411 are joined at a pivot point 412 and are pulled apart by cable 218, as shown. A fusible link member 413 holds the two articulating arms in the position. When a temperature close to the fusible link member 413 causes it to melt or otherwise structurally fail, the tension from cable 218 pulls the articulating members apart, which causes the overall tension in the cable to drop. This triggers the fire suppression system and causes a fire suppressant to be ejected from the nozzles 107A. In embodiments, the triggering is mechanical, such that a valve is opened as a result of the released tension in cable 218.

As shown in FIG. 4, temperature sensor 104 is provided in close vicinity of the fusible link member 413, to allow the system to measure the ambient temperature close to the fusible link member 413 and to allow the detection of a temperature that is about to trigger the fire suppression system, but before the fire suppression system is actually triggered. In embodiments, the temperature sensor 104 is an analog temperature sensor. In embodiments, the sensor 104 is less than 5 cm from the fusible link member 413. In embodiments, the distance is less than 30 cm. In embodiments, the distance between the temperature sensor 104 and the cooking appliance which is expected to generate the most heat underneath the exhaust hood is substantially the same as the distance between the link member 413 and that same appliance. This allows about the same amount of thermal energy to reach the link 413 and the sensor 104, and provides a more accurate approximation of the temperature at the fusible link 413.

In an embodiment, there are two temperature sensors 104 provided at to opposite ends of the exhaust hood 121. These two temperature sensors 104 allow the detection of heat that can warn of an impending fire suppression release.

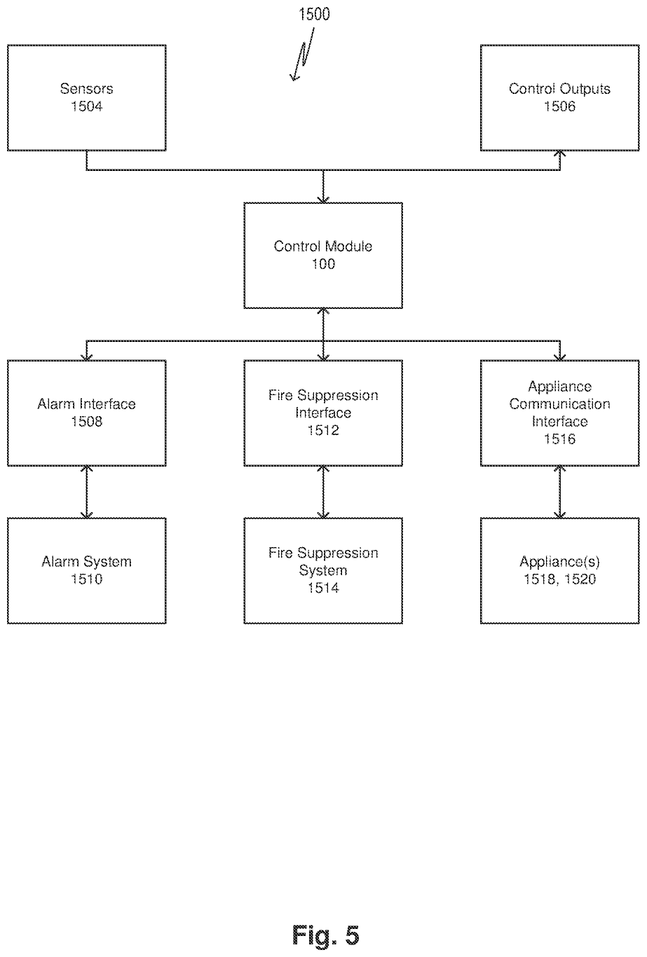

FIG. 5 is a block diagram of an exemplary fire detection and warning system in accordance with the present disclosure. In embodiments, the system can also control exhaust flow rate using the same controller and sensors as used for the fire detection and warning. In particular, a system 1500 includes a control module 100 (or 200) coupled to sensors 1504 and control outputs 1506. The control module 100 or 200, as described above, is also coupled to an alarm interface 1508, a fire suppression interface 1512, and an appliance communication interface 1516. The alarm interface 1508 is coupled to an alarm system 1510. The fire suppression interface 1512 is coupled to a fire suppression system 1514. The appliance communication interface 1516 is coupled to one or more appliances 1518, 1520. The appliance communication interface can turn off power to the appliances, turn them off, or reduce their output in response to a fire warning. In embodiments, when a fire warning condition is reached, the control module can output a warning through the alarm interface and additionally, or alternatively, command one or more appliances to power off or to reduce power output. The command may cause an electrical relay to turn off power to electrically powered appliances and to turn off gas valves of gas supplies on gas powered appliances.

Additionally, the control module 100 can activate a fire suppression system 1514 to apply a fire suppressant locally, to a specific area under the exhaust hood, minimizing the disruption to other areas under the hood. This is in contrast with the fusible link fire suppression system, which may be present also as a fail-safe system and which would normally discharge fire suppressant from multiple nozzles, even those which are not directed at the actual source of the particular fire.

In operation, the control module 100/200 can communicate and exchange information with the alarm system 1510, fire suppression system 1514, and appliances 1518-1520 to better monitor fire conditions. Also, the control module 100/200 may provide information to the various systems (1510-1520) so that functions can be coordinated for a more effective operational environment. For example, the control module 100/200, through its sensors 1504, may detect a fire or a condition just before a fusible link fire suppression system would trigger, and issue a notification that allows an operator to take steps to end the condition and preclude the fusible fire suppression system from triggering.

The control module 100/200 can also communicate this information to the alarm system 1510, the fire suppression system 1514, and the appliances 1518, 1520 so that each device or system can take appropriate actions. In embodiments the appliances are powered off (interrupting electrical power and/or fuel source such as gas or propane.)

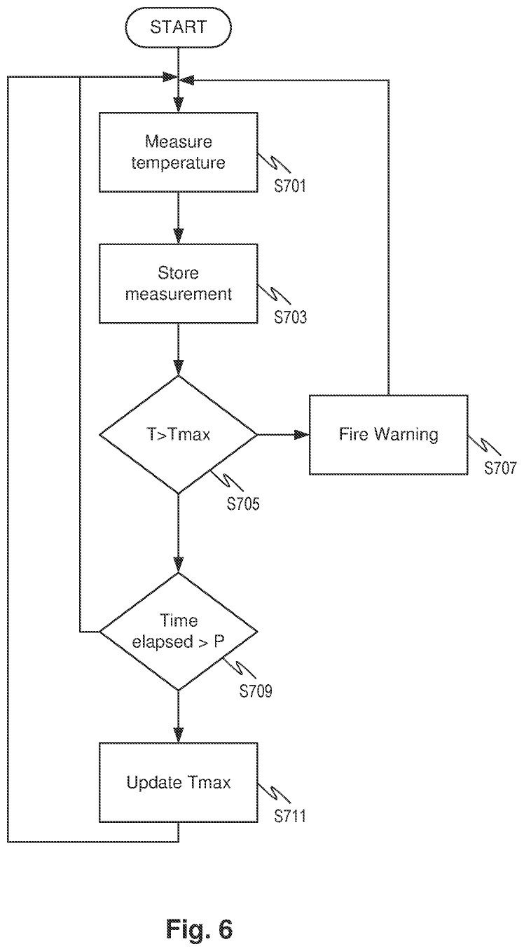

Turning to FIG. 6, a process according to embodiments of the disclosure is illustrated. The process may be used to determine whether a fire condition exists or is about to exist such that a fusible link may be triggered. A threshold temperature Tmax is selected based on the fusible link rated temperature. In embodiments, Tmax is equal to the rated temperature. In other embodiments, Tmax is 1, 2, 3, 4, or 5, degrees Fahrenheit lower than the rated temperature. When the temperature sensor 104 is positioned close to the fusible link member 413, the measured temperature reflects the temperature at the fusible link and can be used to predict whether the fusible link is about to melt or break.

At S701, the temperature is measured by sensor 104, and stored at S703. The storage of the measured temperature allows the creation of a historical record which shows trends in the temperature. The temperature is stored along with metadata including measurement time, date, appliance status, and ventilation hood status (including exhaust flow rates). This data can be supplied to an artificial intelligence system to perform supervised learning based on these stored data and to derive from it conditions that call for a warning or other alert.

At S705 the measured temperature is compared to Tmax, described above. If the measured temperature T exceeds Tmax at all, a fire warning may be generated at S707. In embodiments, Tmax is compared to T multiple times over a time duration to effectively integrate the amount of thermal energy and only when the amount of thermal energy in a particular time period exceeds a threshold value, then a warning is generated. This approach takes into consideration the physical properties of the fusible link 413, recognizing that various conditions could melt the link. A high temperature for a short period of time could melt the link, but if the temperature is reduced slightly, it would take a longer time to melt the link. Hence the controller stores the temperature measurements so that these various conditions can be recognized and a warning can be generated before the link melts.

If the temperature does not exceed Tmax, at S709 the total time elapsed during which the measurements have been taken is compared to a time period P. In embodiments, P is 60 days, 45 days, 30 day, 14 days, 7 days, or a one day. For example, if the period P is 30 days, and T has not exceeded Tmax, it is determined that Tmax is set too high. Thus, at S711 the value of Tmax is updated to a lower value, and the process continues. In effect, this allows the system to learn over time what is considered to be a normal temperature inside the exhaust hood and to set Tmax accordingly. Then, if Tmax is exceeded, it is a strong indication of a possible fire condition that results in a warning at S707.

Embodiments of a method, system and computer program product for controlling exhaust flow rate, may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions or steps described herein can be used to implement embodiments of the method, system, or computer program product for controlling exhaust flow rate.

Furthermore, embodiments of the disclosed method, system, and computer program product for controlling exhaust flow rate may be readily implemented, fully or partially, in software using, for example, object or object-oriented software development environments that provide portable source code that can be used on a variety of computer platforms. Alternatively, embodiments of the disclosed method, system, and computer program product for controlling exhaust flow rate can be implemented partially or fully in hardware using, for example, standard logic circuits or a VLSI design. Other hardware or software can be used to implement embodiments depending on the speed and/or efficiency requirements of the systems, the particular function, and/or a particular software or hardware system, microprocessor, or microcomputer system being utilized. Embodiments of the method, system, and computer program product for controlling exhaust flow rate can be implemented in hardware and/or software using any known or later developed systems or structures, devices and/or software by those of ordinary skill in the applicable art from the functional description provided herein and with a general basic knowledge of the computer, exhaust flow, and/or cooking appliance arts.

Moreover, embodiments of the disclosed method, system, and computer program product for controlling exhaust flow rate can be implemented in software executed on a programmed general-purpose computer, a special purpose computer, a microprocessor, or the like. Also, the exhaust flow rate control method of this invention can be implemented as a program embedded on a personal computer such as a JAVA® or CGI script, as a resource residing on a server or graphics workstation, as a routine embedded in a dedicated processing system, or the like. The method and system can also be implemented by physically incorporating the method for controlling exhaust flow rate into a software and/or hardware system, such as the hardware and software systems of exhaust vent hoods and/or appliances.

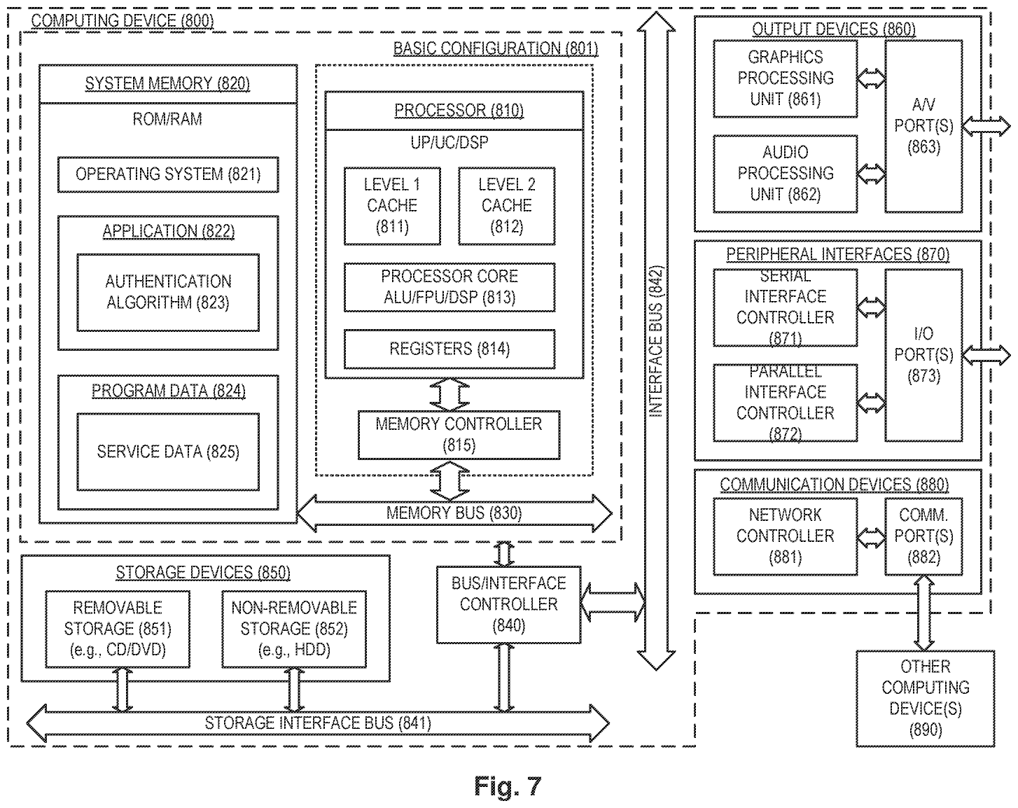

FIG. 7 illustrates an exemplary embodiment of the various controllers 100 and 200 described above, embodied as a computing device 800. FIG. 7 is a block diagram illustrating an example of computing device 800 that is arranged for controlling a dual-mode light fixtures, disinfecting return grilles, and/or HVAC systems in accordance with the present disclosure. In a very basic configuration 801, computing device 800 typically includes one or more processors 810 and system memory 820. A memory bus 830 can be used for communicating between the processor 810 and the system memory 820.

Depending on the desired configuration, processor 810 can be of any type including but not limited to a microprocessor (μP), a microcontroller (μC), a digital signal processor (DSP), or any combination thereof. Processor 810 can include one more levels of caching, such as a level one cache 811 and a level two cache 812, a processor core 813, and registers 814. The processor core 813 can include an arithmetic logic unit (ALU), a floating point unit (FPU), a digital signal processing core (DSP Core), or any combination thereof. A memory controller 815 can also be used with the processor 810, or in some implementations the memory controller 815 can be an internal part of the processor 810.

Depending on the desired configuration, the system memory 820 can be of any type including but not limited to volatile memory (such as RAM), non-volatile memory (such as ROM, flash memory, etc.) or any combination thereof. System memory 820 typically includes an operating system 821, one or more applications 822, and program data 824. Application 822 includes a multipath processing algorithm 823 that is arranged to control the light fixtures and the overall system according to the disclosed embodiments. Program Data 824 includes data 825 that is useful for controlling a dual-mode light fixtures, disinfecting return grilles, and/or HVAC systems, as will be further described below. In some embodiments, application 822 can be arranged to operate with program data 824 on an operating system 821. This described basic configuration is illustrated in FIG. 7 by those components within dashed line enclosing number 801.

Computing device 800 can have additional features or functionality, and additional interfaces to facilitate communications between the basic configuration 801 and any required devices and interfaces. For example, a bus/interface controller 840 can be used to facilitate communications between the basic configuration 801 and one or more data storage devices 850 via a storage interface bus 841. The data storage devices 850 can be removable storage devices 851, non-removable storage devices 852, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 820, removable storage 851 and non-removable storage 852 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media can be part of device 800.

Computing device 800 can also include an interface bus 842 for facilitating communication from various interface devices (e.g., output interfaces, peripheral interfaces, and communication interfaces) to the basic configuration 801 via the bus/interface controller 840. Example output devices 860 include a graphics processing unit 861 and an audio processing unit 862, which can be configured to communicate to various external devices such as a display or speakers via one or more A/V ports 863. Example peripheral interfaces 870 include a serial interface controller 871 or a parallel interface controller 872, which can be configured to communicate with external devices such as input devices (e.g., keyboard, mouse, pen, voice input device, touch input device, etc.) or other peripheral devices (e.g., sensors 104.) via one or more I/O ports 873. An example communication device 880 includes a network controller 881, which can be arranged to facilitate communications with one or more other computing devices 890 over a network communication via one or more communication ports 882. The communication connection is one example of a communication media. Communication media may typically be embodied by computer readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 800 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 800 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

According to a first aspect of the disclosed subject matter, a fire detection and warning system includes a kitchen exhaust hood connected to an exhaust fan configured to ventilate convective heat and cooking fumes released by one or more cooking appliances installed under the kitchen exhaust hood, the kitchen exhaust hood having a plenum; a fire suppression system operatively connected to the hood and positioned above the one or more cooking appliances, the fire suppression system being configured to be triggered by one or more fusible links with a predefined melting temperature to discharge a fire suppressing agent; at least one temperature sensor installed inside the plenum of the kitchen exhaust hood; a control module operatively connected to the at least one temperature sensor and receiving signals indicating a temperature measurement by the at least one temperature sensor, wherein the control module is configured to generate a fire warning signal in response to a fume temperature reaching a predefined temperature threshold Tset for a predefined period of time Tdur, and the temperature threshold Tset and the time duration Tdur are selected based on a melting temperature rating of at least one of the one or more fusible links.

According to variations thereof, the fire detection and warning system further includes the one or more cooking appliances installed under the kitchen exhaust hood. According to further variations, the fire detection and warning system includes two temperature sensors positioned at opposite ends of the plenum of the kitchen exhaust hood on two sides of an exhaust collar.

According to further variations, the at least one temperature sensor is positioned directly above a cooking appliance with a highest heat signature or fire risk.

According to further variations, the predefined temperature setpoint is below a predefined fusible link temperature.

According to further variations, the control module is configured to record the temperature sensor reading output for an extended period of time.

According to further variations, the extended period of time is 5 days, 1 week, 2 weeks, 4 weeks, one month, two months, three months, four months, five months, or six months.

According to further variations, the control module is configured to determine whether the predefined fusible link temperature Tset had been exceeded during the extended period of time, and to update the temperature Tset to a lower value that represents the highest temperature value measured during the extended period of time.

According to further variations, the control module is configured to update the temperature Tset to Tmax−dT, where Tmax is the maximum recorded temperature and dT is a predefined temperature range limit.

According to further variations, dT is 10 degrees Fahrenheit or less.

According to further variations, the fire detection and warning system includes one or more thermal imaging sensors located under the kitchen exhaust hood and configured to monitor surface temperature of the cooking appliances under the hood and providing output signals to the control module.

According to further variations, the control module determines whether to output a fire warning based on the temperature signals from the temperature sensors and based on the output signals provided by the one or more thermal imaging sensors.

According to further variations, appliance heat signature HS (surface temperature and pixel area) is recorded for an extended period of time (at least 30 days) and typical HS pattern (baseline) is established.

According to further variations, HS pattern is used to establish a historical baseline and detect any anomalies that may cause potential fire.

According to further variations, image recognition algorithms are used to establish a baseline signature and anomalies.

According to further variations of any of the above aspects and variations, T and HS are recorded during a fire event and fire signature is established as a combination of T and HS recorded in time.

According to further variations of any of the above aspects and variations, the fire risk factor is calculated using deviation of the current values of T and HS from those representing a fire signature.

According to further variations of any of the above aspects and variations, a space temperature sensor Tr is used.

According to further variations of any of the above aspects and variations, Tr is used to offset T reading where fluctuation of Tr during the year exceeds 5° F.

According to further variations of any of the above aspects and variations, multiple temperature sensors are used to engage the fire suppression system.

According to a second aspect of the disclosed subject matter, a method of identifying a fire risk condition includes providing a kitchen exhaust hood with a plenum and an exhaust duct connected to the plenum, the kitchen exhaust hood having a fire suppression system with fusible links installed; positioning at least one temperature sensor inside the plenum; providing a control module operatively connected to the at least one temperature sensor; receiving at the control module a signal representing temperature inside the plenum from the at least one temperature sensor; comparing the temperature inside the plenum with a temperature representing a melting temperature of the fusible links; and outputting a warning signal from the control module in response to a result of the comparing.

According to variations thereof, the warning signal is provided to a communication module that communicates with a mobile user device.

According to further variations, the melting temperature of at least one of the fusible links is Tm, the temperature sensor is positioned no farther than a distance D from the at least one of the fusible links with the melting temperature Tm, and the result of the comparing indicates the fire risk condition when the measured temperature is within 5 degrees Fahrenheit of Tm and the distance D is 5 cm or less.

According to further variations, the melting temperature of at least one of the fusible links is Tm, the temperature sensor is positioned no farther than a distance D from the at least one of the fusible links with the melting temperature Tm, and the result of the comparing indicates the fire risk condition when the distance D is 5 cm or less and the measured temperature is within 5 degrees Fahrenheit of Tm for a duration of time Td.

According to further variations, the duration time Td is summed up over a sampling interval until the total combined duration during a window period Tw exceeds a time Tmax.

According to further variations, Td is 30 seconds, 1 minute, 2 minutes, 3 minutes, or 5 minutes and Tmax is 1 minutes, 2 minutes, 3 minutes, 5 minutes, or 10 minutes.

According to a third aspect of the disclosed subject matter, a method of reacting to a fire risk condition in or under a ventilation hood includes providing a first fire suppression system in or under the ventilation hood, the first fire suppression system having fusible link trigger mechanism; providing a second fire suppression system in or under the ventilation hood, the second fire suppression system having a separate trigger mechanism from the first fire suppression system; identifying the fire risk condition; in response to the identifying, outputting a warning perceptible to a user of the ventilation hood; determining whether a fire condition is present; and in response to the determining, triggering the second fire suppression system in a targeted manner to only suppress areas under the ventilation hood experiencing the fire condition.

According to variations of the third aspect, the identifying the fire risk condition implements a method according to any of variations of the first aspect.

According to further variations of any of the above aspects and their variations, the method further includes triggering the first fire suppression system in response to a fusible link of the fusible link trigger mechanism melting or in response to a control signal from a controller of the second fire suppression system.

According to a fourth aspect of the disclosed subject matter, a method of adding a fire detection and warning system to a kitchen exhaust hood with a fire suppression system includes providing a kitchen exhaust hood that includes a plenum connected to an exhaust duct, a controller configured to control at least exhaust flow rate through the exhaust duct, and a fire suppression system configured to discharge a fire suppressant under the kitchen exhaust hood in response to a detection of a fire condition; and configuring the controller to measure temperature in the vicinity of fire sensors of the fire suppression system and to output a fire risk warning in response to the measured temperature exceeding a predetermined temperature Tset for a duration exceeding Tdur.

According to variations thereof, the fire suppression system includes fusible links which are configured to melt at a specified temperature and thereby trigger the fire suppression system.

According to further variations, the vicinity is closer than 50 cm, closer than 40 cm, closer than 30 cm, closer than 20 cm, closer than 10 cm, or closer than 5 cm.

According to further variations, Tset is equal or less than a specified melting temperature of fusible links of the fire suppression system.

According to further variations, Tset is equal to a specified melting temperature of fusible links of the fire suppression system.

According to further variations, Tset is equal to the specified melting temperature of the fusible links of the fire suppression system minus an amount Tdelta.

According to further variations, Tdelta is 1 degree Fahrenheit, 2 degrees Fahrenheit, 3 degrees Fahrenheit, or 4 degrees Fahrenheit.

According to further variations, the method includes installing at least one temperature sensor in the vicinity of at least one of the fire sensors.

According to further variations, two temperature sensors are installed at opposite ends of the plenum.

According to further variations, the method includes installing at least one radiant temperature sensor under the exhaust hood with a direct line of sight view of the fire sensors of the fire suppression system, wherein the at least one radiant temperature sensor is aimed to measure radiant temperature of at least one of the fire sensors.

According to a fifth aspect of the disclosed subject matter, a method of verifying operation of a fire suppression system includes providing a fire suppression system configured to discharge a fire suppressant in response to a detection of a fire, wherein the fire suppression system includes one or more fire detectors; monitoring the one or more fire detectors with one or more temperature sensors and outputting signals from the one or more temperature sensors to a controller; and generating a fire warning signal by the controller in response to a temperature measured by the temperature sensors exceeding a threshold temperature Tset for a duration Tdur.

According to variations thereof, the one or more fire detectors include fusible links with a predetermined melting temperature.

According to further variations, the method further includes generating a warning indicating failure of the fire suppression system in response to the temperature measured by the temperature sensors exceeding the predetermined melting temperature without the fire suppression system discharging the fire suppressant.

According to a sixth aspect of the disclosed subject matter a kitchen ventilation system with a primary and secondary fire suppression system is provided and controlled based on measured temperature.

It should be apparent that all of the aspects and variations thereof expressly described can be combined to produce further embodiments. Many alternatives, modifications, and variations are enabled by the present disclosure. Features of the disclosed embodiments can be combined, rearranged, omitted, etc., within the scope of the disclosure to produce additional embodiments. Furthermore, certain features may sometimes be used to advantage without a corresponding use of other features. Accordingly, Applicants intend to embrace all such alternatives, modifications, equivalents, and variations that are within the spirit and scope of the present disclosure.

1. A fire detection and warning system, comprising:
kitchen exhaust hood connected to an exhaust fan configured to ventilate convective heat and cooking fumes released by one or more cooking appliances installed under the kitchen exhaust hood, the kitchen exhaust hood having a plenum;
a fire suppression system operatively connected to the hood and positioned above the one or more cooking appliances, the fire suppression system being configured to be triggered by one or more fusible links with a predefined melting temperature to discharge a fire suppressing agent;
at least one temperature sensor installed inside the plenum of the kitchen exhaust hood;
a control module operatively connected to the at least one temperature sensor and receiving signals indicating a temperature measurement by the at least one temperature sensor, wherein
the control module is configured to generate a fire warning signal in response to a fume temperature T measured by the at least one temperature sensor reaching a predefined temperature threshold Tₛₑₜ for a predefined period of time T_{dur}, and
the temperature threshold Tₛₑₜ and the time duration T_{dur} are selected based on a melting temperature rating of at least one of the one or more fusible links.

2. The fire detection and warning system according to claim 1, further comprising:
the one or more cooking appliances installed under the kitchen exhaust hood.

3. The fire detection and warning system according to claim 1, comprising:
two temperature sensors positioned at opposite ends of the plenum of the kitchen exhaust hood on two sides of an exhaust collar.

4. The fire detection and warning system according to claim 1, wherein
the at least one temperature sensor is positioned directly above a cooking appliance with a highest heat signature or fire risk.

5. The fire detection and warning system according to claim 1, wherein
the predefined temperature setpoint is below a predefined fusible link temperature.

6. The fire detection and warning system according to claim 1, wherein
the control module is configured to record the temperature sensor reading output for an extended period of time.

7. (canceled)

8. The fire detection and warning system according to claim 6, wherein
the control module is configured to determine whether the predefined fusible link temperature Tₛₑₜ had been exceeded during the extended period of time, and to update the temperature Tₛₑₜ to a lower value that represents the highest temperature value measured during the extended period of time.

9. The fire detection and warning system according to claim 6, wherein
the control module is configured to update the temperature Tₛₑₜ to Tₘₐₓ−dT, where Tₘₐₓ is the maximum recorded temperature and dT is a predefined temperature range limit.

10. (canceled)

11. The fire detection and warning system according to claim 1, further comprising:
one or more thermal imaging sensors located under the kitchen exhaust hood and configured to monitor surface temperature of the cooking appliances under the hood and provide output signals to the control module,
wherein the control module determines whether to output a fire warning based on the temperature signals from the temperature sensors and based on the output signals provided by the one or more thermal imaging sensors.

12. (canceled)

13. The system of claim 11, wherein appliance a heat signature HS including the surface temperature and a pixel area is recorded for an extended period of time of at least 30 days and a typical HS pattern is established.

14. The system of claim 8, wherein a heat signature pattern is used to establish a historical baseline and detect any anomalies that may cause potential fire.

15. The system of claim 8, wherein image recognition algorithms are used to establish a baseline signature and anomalies.

16. The system of claim 13, wherein T and HS are recorded during a fire event and fire signature is established as a combination of T and HS recorded in time.

17. The system of claim 13, wherein fire risk factor is calculated using deviation of the current values of T and HS from those representing a fire signature.

18. The system of claim 1, wherein space temperature sensor Tr is used to offset T reading where fluctuation of Tr during the year exceeds 5° F.

19-20. (canceled)

21. A method of identifying a fire risk condition, comprising:
providing a kitchen exhaust hood with a plenum and an exhaust duct connected to the plenum, the kitchen exhaust hood having a fire suppression system with fusible links installed;
positioning at least one temperature sensor inside the plenum;
providing a control module operatively connected to the at least one temperature sensor;
receiving at the control module a signal representing temperature inside the plenum from the at least one temperature sensor;
comparing the temperature inside the plenum with a temperature representing a melting temperature of the fusible links; and
outputting a warning signal from the control module in response to a result of the comparing.

22-29. (canceled)

30. A method of adding a fire detection and warning system to a kitchen exhaust hood with a fire suppression system, the method comprising:
providing a kitchen exhaust hood that includes a plenum connected to an exhaust duct, a controller configured to control at least exhaust flow rate through the exhaust duct, and a fire suppression system configured to discharge a fire suppressant under the kitchen exhaust hood in response to a detection of a fire condition; and
configuring the controller to measure temperature in the vicinity of fire sensors of the fire suppression system and to output a fire risk warning in response to the measured temperature exceeding a predetermined temperature Tset for a duration exceeding Tdur.

31-42. (canceled)

43. A method of verifying operation of a fire suppression system, comprising:
providing a fire suppression system configured to discharge a fire suppressant in response to a detection of a fire, wherein the fire suppression system includes one or more fire detectors;
monitoring the one or more fire detectors with one or more temperature sensors and outputting signals from the one or more temperature sensors to a controller; and
generating a fire warning signal by the controller in response to a temperature measured by the temperature sensors exceeding a threshold temperature Tset for a duration Tdur.

44-46. (canceled)
